(19) United States
(12) Patent Application Publication
(10) Pub. No.: US 2011/0158505 A1
(43) Pub. Date: Jun. 30, 2011

(54) STEREO PRESENTATION METHOD OF DISPLAYING IMAGES AND SPATIAL STRUCTURE

(75) Inventor: Chun-wang Sun, Taipei City (TW)

(73) Assignee: National Taiwan University of Science and Technology, Taipei City (TW)

(21) Appl. No.: 12/727,883

(22) Filed: Mar. 19, 2010

(30) Foreign Application Priority Data
Dec. 28, 2009 (TW) 098145346

(51) Int. Cl. G06K 9/00

(52) U.S. Cl. 382/154

(57) ABSTRACT

An image stereo presentation method, comprising steps of: establishing at least one three-dimensional (3D) model corresponding to a physical stereo object; projecting a planar image onto the 3D model at a specific angle, wherein the 3D model has an interface adjoining at least two surfaces in a range of projecting the planar image, and the said two surfaces are not on the same plane; extracting at least two sub-images from the said two surfaces whereby the planar image is projected onto; and forming the said two sub-images on two physical surfaces of the physical stereo object corresponding to the said two surfaces. The image stereo presentation method is capable to present a special visual effect.

### CLAIM OF PRIORITY

This application claims priority to Taiwanese Patent Application No. 098145346 filed on Dec. 28, 2009.

### TECHNICAL FIELD OF THE INVENTION

The present invention relates to a stereo presentation method and a spatial structure, and more particularly, to a stereo presentation method of displaying a planar image, and a spatial structure applying the same.

### BACKGROUND OF THE INVENTION

As printing techniques have been developed and widely used by now, various types of products or boxes for packing the products can be decorated with beautiful images to attract consumers and entice their desires to buy the products. In addition, physical objects or devices self-containing advertising benefits or capable of conveying some ideas are often attached with images.

Generally, these images are simply attached to the stereo objects, just merely attached to a surface or attached around a couple of surfaces. The shape or appearance is an important factor to design the stereo objects. The representation of the attached images is also a key to improve the design. However, objects or devices having images designed according to their inherent structures for enhancing a visual effect are rare to see.

Therefore, the present invention puts an emphasis on image representation on physical objects or devices, and provides an image stereo presentation method and a spatial structure herein.

### SUMMARY OF THE INVENTION

An objective of the present invention is to provide an image stereo presentation method for utilizing a geometrical structure inherently resided in a stereo object for displaying images.

Another objective of the present invention is to provide an image stereo presentation method for displaying images in a special visual effect.

Yet another objective of the present invention is to provide a spatial structure for utilizing its geometrical structure for displaying images in a special visual effect.

According to the above objectives, the present invention provides an image stereo presentation method, which comprises steps of: establishing at least one three-dimensional (3D) model corresponding to a physical stereo object; projecting a planar image onto the 3D model at a specific angle, wherein the 3D model has an interface adjoining at least two surfaces in a range of projecting the planar image, and the said two surfaces are not on the same plane; extracting at least two sub-images from the said two surfaces whereby the planar image is projected onto; and forming the said two sub-images on two physical surfaces of the physical stereo object corresponding to the said two surfaces.

The present invention further provides a spatial structure, which comprises: an interface adjoining at least two physical surfaces that are not on the same plane; and at least two deformed sub-images being disposed on the said two physical surfaces, wherein a user will observe that the two deformed sub-images are merged and turned to an un-deformed image when the user looks at the spatial structure at a specific angle.

In the embodiments of the present invention, the sub-images on the physical surfaces can be presented by (1) printing out the sub-images and attaching them to the physical surfaces, and (2) displaying the sub-images on the screens which are disposed on the physical surfaces.

The present invention may be applied to product packaging, advertisement, or decorative art, and is able to present an interesting visual effect thereupon. In the field of product packaging, the present invention can be applied to a stereo structure of a product itself or a box for packaging the product to give people a new experience. In the field of advertisement, the present invention may enhance the effect of advertisement. Specifically, the present invention can be applied to the advertising board adhered to outer walls of buildings, or any type of stereo structure devices having advertising benefits. In addition, the present invention may be implemented as arranging digital screens on the outer walls of buildings to display images or videos for advertising or conveying some ideas. Moreover, the present invention can be applied to any type of objects having a stereo structure. Stereo objects just for viewing and admiring may also lie within the scope of the present invention.

### BRIEF DESCRIPTION OF THE DRAWINGS

The present invention will be described in details in conjunction with the appending drawings.

FIG. 1 is a diagram showing a flow chart of an image stereo presentation method implemented according to the present invention.

FIG. 2 is a diagram showing a flow chart of another image stereo presentation method implemented according to the present invention.

FIG. 3 is a diagram showing a spatial structure of a first embodiment of the present invention.

FIG. 4a, FIG. 4b, and FIG. 4c are diagrams respectively showing that the image ILLUSION presented on physical surfaces is divided as sub-images that actually are twisted or deformed in the first embodiment of the present invention.

FIG. 5 is a diagram showing a spatial structure of a second embodiment of the present invention.

FIG. 6a, FIG. 6b, and FIG. 6c are diagrams respectively showing that an image of a model presented on display screens is divided as sub-images that actually are twisted or deformed in the second embodiment of the present invention.

### DETAILED DESCRIPTION OF THE INVENTION

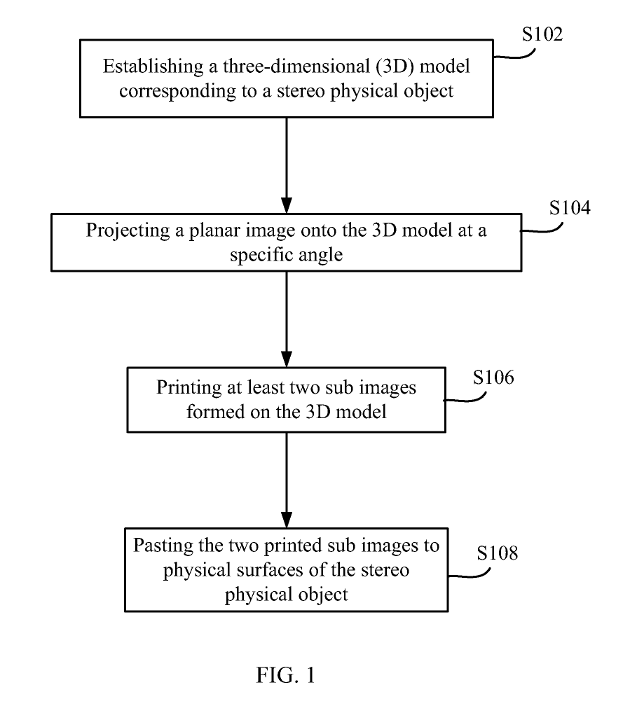

Please refer to FIG. 1, which is a diagram showing a flow chart of an image stereo presentation method implemented according to the present invention. The present invention will be described in detail in conjunction with FIG. 1.

Step S102: In the beginning, a model is made according to a physical stereo object. More specifically, a three-dimensional (3D) model corresponding to the physical stereo object is established. The 3D model is proportional to the physical stereo object, or the two are in the same size. In this step, computer-aided design (CAD), such as MAYA and AutoCAD, may be utilized to establish the 3D model.

Step S104: Next, a planar image is projected onto the 3D model at a specific angle. The 3D model has an interface (a vertex or an edge) adjoining at least two surfaces that are not on the same plane. In a path the 3D model being projected, the projected planar image is divided into a plurality of sub-images formed on the said surfaces. These sub-images are twisted or deformed. They are changed in shape as compared to the original or normal planar image. In this step, CAD software may be utilized in processing the planar image to project onto the 3D model.

Step S106: The sub-images on the said surfaces that the planar image is projected onto in Step S104, are printed. In this step, the sub-images that are formed on the 3D model may be extracted and saved as image files, and then print out the sub-images of the image files, respectively.

Step S108: Finally, the printed sub-images are directly pasted to physical surfaces of the physical stereo object. When an A surface of the 3D model corresponds to an A′ physical surface of the physical stereo object, the sub-image formed on the A surface of the 3D model is pasted to the A′ physical surface of the physical stereo object. The “correspond” or “corresponding” is referred to a structural correspondence of the physical stereo object and the 3D model.

According to the above steps, the sub-images adhered on the physical stereo object are twisted or deformed, inherently. However, an untwisted or un-deformed image, identical to the planar image, will be observed when looking at the physical stereo object from the specific angle that the planar image is projected. Otherwise, at other angles, the observed images will be twisted, split images. Therefore, the sub-images on the physical stereo object may lead to an interesting visual effect.

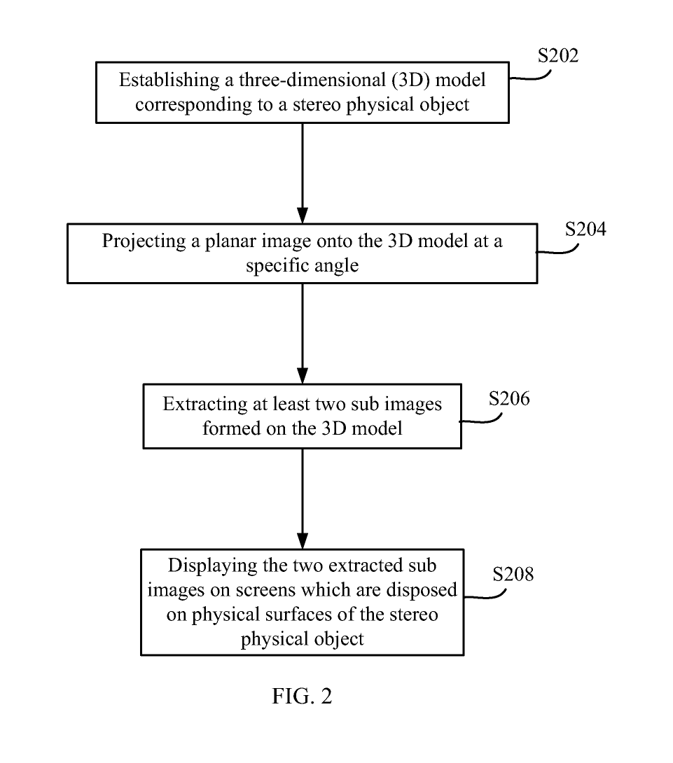

Please refer to FIG. 2, which is a diagram showing a flow chart of another image stereo presentation method implemented according to the present invention. The main difference between this implementation and the previous implementation is how to present the sub-images. It will be described in details as follows.

Step S202: A corresponding three-dimensional (3D) model is established according to a physical stereo object.

Step S204: A planar image is projected onto the 3D model at a specific angle.

Steps S202 and S204 are respectively similar to Steps S102 and S104 as previously described. The description of Steps S202 and S204 will be omitted herein for clear and concise purpose.

Step S206: The sub-images on the said surfaces that the planar image is projected onto are extracted. In this step, the extracted sub-images are twisted. These sub-images may be saved as bitmaps or as vector graphics including the deformation information.

Step S208: The physical stereo object corresponding to the 3D model in structure has physical surfaces. The physical surfaces have screens disposed thereon. The sub-images extracted in Step 206 are displayed on corresponding screens, respectively. In this step, the screens are made by electronic components, for example, pixel arrays capable of displaying an image. The screens on the physical surfaces may be implemented as display screens of liquid crystal displays (LCDs), electrophoretic displays (EPDs), or flexible displays. For example, electronic paper, a display technology in development, may be utilized for display screens disposed on the physical surfaces of the physical stereo object.

The image stereo presentation method implemented according to the present invention may be applied to product packaging, advertisement, decorative art, and so on. This stereo presentation method is capable to present an interesting visual effect. In the field of product packaging, the present invention can be applied to a stereo structure of a product itself or a box for packaging the product to give people a new experience. In the field of advertisement, the image stereo presentation method may enhance the effect of advertisement. Specifically, the present invention can be applied to the advertising board adhered to outer walls of buildings, or any type of stereo structure devices having advertising benefits. In addition, the present invention may be implemented as arranging digital screens on the outer walls of buildings to display images or videos for advertising or conveying some ideas. Moreover, the present invention can be applied to any type of objects having a stereo structure. Stereo objects just for viewing and admiring may also lie within the scope of the present invention.

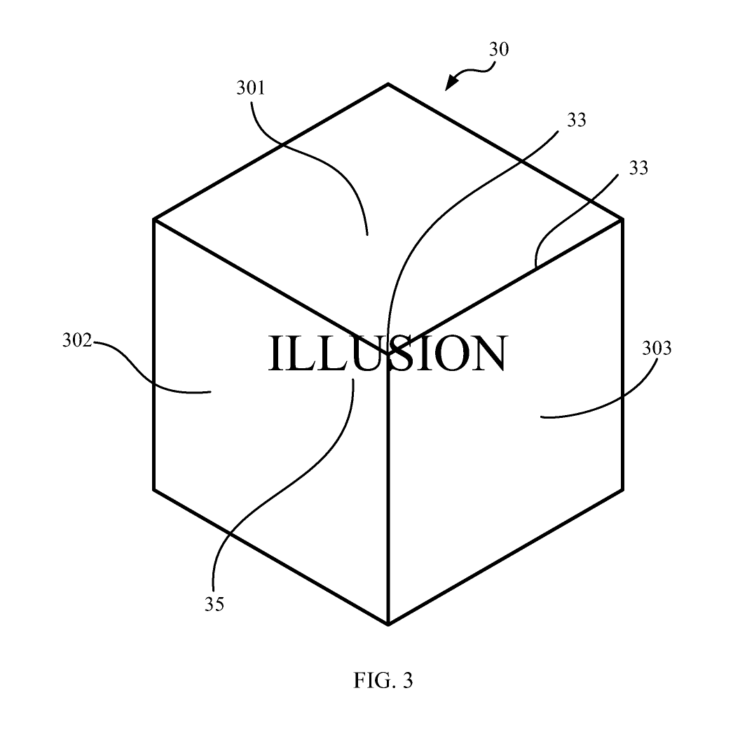

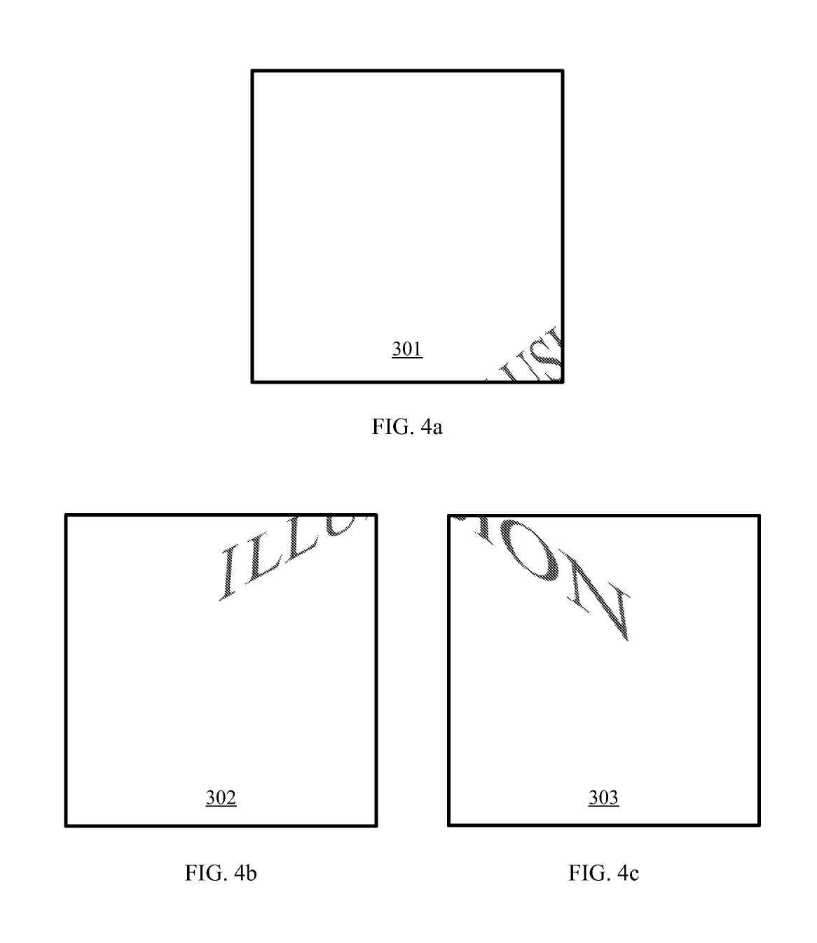

Please refer to FIG. 3, which is a diagram showing a spatial structure 30 of a first embodiment of the present invention. In this embodiment, the spatial structure 30 has an interface 33 adjoining physical surfaces 301, 302, 303 that are not on the same plane. The interface 33 may be a vertex or an edge of the spatial structure 30. The physical surfaces 301, 302, 303 are respectively attached with sub-images that are twisted or deformed as shown in FIG. 4a, FIG. 4b, and FIG. 4c. It is noted that the image presented in FIG. 3 is observed at a specific angle. However, twisted or deformed images will be observed when looking at the spatial structure 30 from other angles. As shown in FIGS. 3, and 4a-4c, the sub-images on the physical surfaces 301, 302, 303 actually are twisted or deformed. However, the image ILLUSION 35 in FIG. 3 appears to be a normal image that is untwisted or un-deformed when observing at the specific angle. Otherwise, at other angles, the observed images will be twisted or deformed in various degrees.

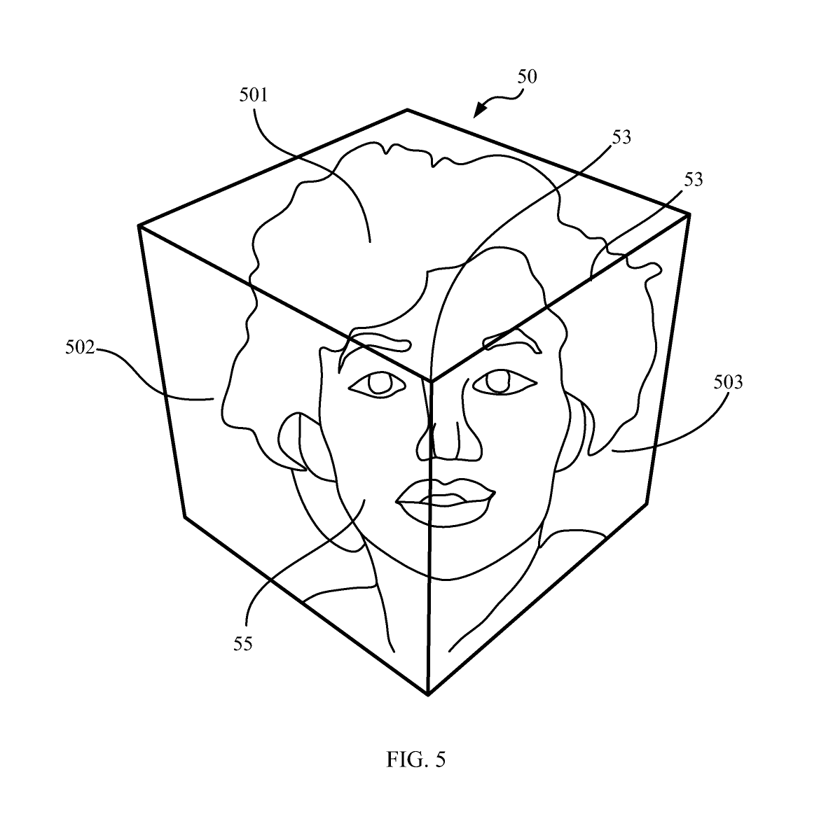

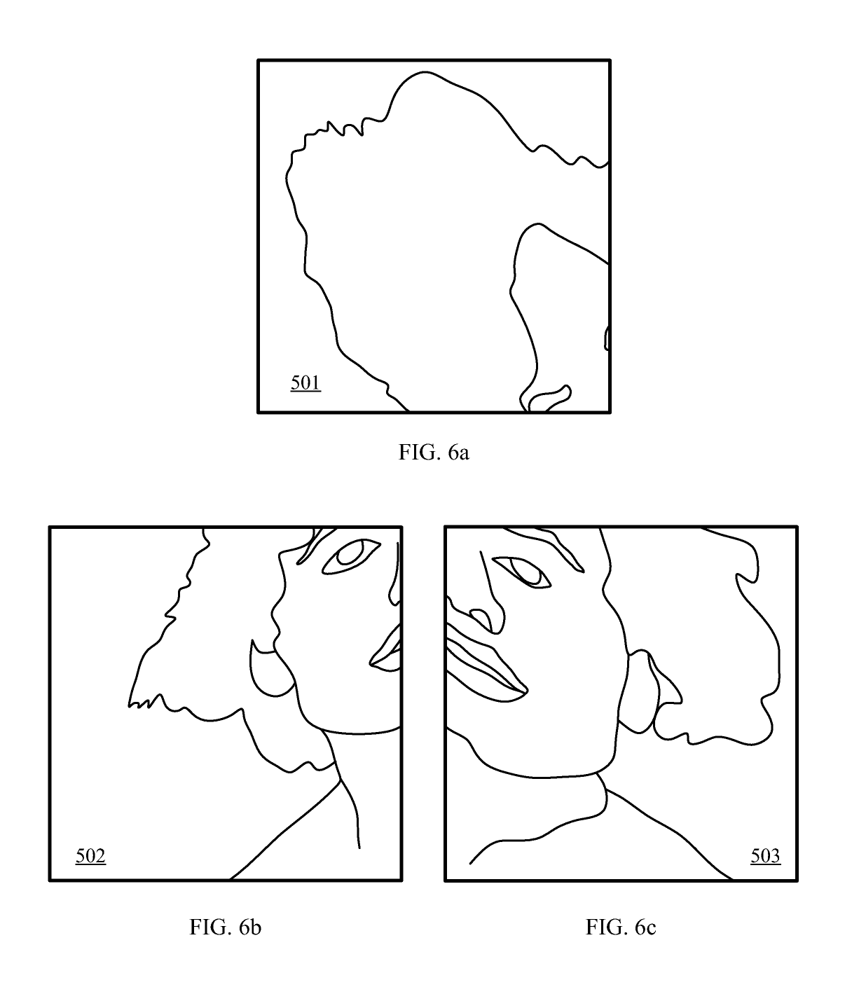

Please further refer to FIG. 5, which is a diagram showing a spatial structure 50 of a second embodiment of the present invention. In this embodiment, sub-images to construct an image of a model 55 are presented by display screens. The screens are made by electronic components, for example, pixel arrays capable of displaying an image. As shown in FIG. 5, the spatial structure 50 has an interface 53 adjoining display screens 501, 502, 503 that are not on the same plane. The interface 53 may be a vertex or an edge of the spatial structure 50. The display screens 501, 502, 503 are disposed on physical surfaces of the spatial structure 50, respectively. The display screens 501, 502, 503 can respectively present the sub-images that are twisted or deformed as shown in FIG. 6a, FIG. 6b, and FIG. 6c. It is noted that the image of the model 55 presented in FIG. 5 is observed at a specific angle by a user. However, twisted or deformed images will be observed when looking at the spatial structure 50 from other angles. As shown in FIGS. 5, and 6a-6c, the sub-images showing on the display screens 501, 502, 503 actually are twisted or deformed. However, the image of the model 55 in FIG. 5 appears to be a normal image that is untwisted or un-deformed when observing at the specific angle. Otherwise, at other angles, the observed images will be twisted or deformed in various degrees.

The spatial structure of the present invention may be applied to a stereo structure of a product itself or a box for packaging the product. The advertising board adhered to outer walls of buildings, or any type of stereo structure devices having advertising benefits, are also applications for the spatial structure of the present invention. The present invention can be applied to any type of objects having a stereo structure. The spatial structure of the present invention can also be a stereo object just for viewing and admiring.

The present invention does not limit to adopt a planar surface as the physical surface of the physical stereo object or the spatial structure. The physical surface to be adhered with a sub-image or to display the sub-image on a screen can be a concave surface or a convex surface. According to the principle of image projection, an original image can always be observed at a projection angle in spite of the type of surfaces a planar image is projected onto.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An image stereo presentation method, comprising steps of:
establishing at least one three-dimensional (3D) model corresponding to a physical stereo object;
projecting a planar image onto the 3D model at a specific angle, wherein the 3D model has an interface adjoining at least two surfaces in a range of projecting the planar image, and the said two surfaces are not on the same plane;
extracting at least two sub-images from the said two surfaces whereby the planar image is projected onto; and
forming the said two sub-images on two physical surfaces of the physical stereo object corresponding to the said two surfaces.

2. The image stereo presentation method of claim 1, further comprising a step of printing the said two sub-images before the step of forming the said two sub-images on the said two physical surfaces.

3. The image stereo presentation method of claim 2, wherein the said two printed sub-images are respectively pasted onto the said two physical surfaces in the step of forming the said two sub-images on the said two physical surfaces.

4. The image stereo presentation method of claim 1, wherein the said two physical surfaces have screens thereon respectively to display the said two sub-images in the step of forming the said two sub-images on the said two physical surfaces.

5. The image stereo presentation method of claim 4, wherein the screens on the said two physical surfaces are display screens of liquid crystal displays (LCDs), electrophoretic displays (EPDs), or flexible displays.

6. The image stereo presentation method of claim 1, wherein the interface is a vertex of the 3D model.

7. The image stereo presentation method of claim 1, wherein the interface is an edge of the 3D model.

8. The image stereo presentation method of claim 1, wherein at least one of the said two surfaces is a plane.

9. The image stereo presentation method of claim 1, wherein at least one of the said two surfaces is a concave surface.

10. The image stereo presentation method of claim 1, wherein at least one of the said two surfaces is a convex surface.

11. A spatial structure, comprising:
an interface adjoining at least two physical surfaces that are not on the same plane; and
at least two deformed sub-images being disposed on the said two physical surfaces;
wherein a user will observe that the two deformed sub-images are merged and turned to an un-deformed image when the user looks at the spatial structure at a specific angle.

12. The spatial structure of claim 11, wherein the two deformed sub-images are adhered to the said two physical surfaces, respectively.

13. The spatial structure of claim 11, wherein the said two physical surfaces have screens thereon respectively to display the two deformed sub-images.

14. The spatial structure of claim 13, wherein the screens on the said two physical surfaces are display screens of liquid crystal displays (LCDs), electrophoretic displays (EPDs), or flexible displays.

15. The spatial structure of claim 11, wherein the interface is a vertex of the spatial structure.

16. The spatial structure of claim 11, wherein the interface is an edge of the spatial structure.

17. The spatial structure of claim 11, wherein at least one of the said two physical surfaces is a plane.

18. The spatial structure of claim 11, wherein at least one of the said two physical surfaces is a concave surface.

19. The spatial structure of claim 11, wherein at least one of the said two physical surfaces is a convex surface.
